(19) United States
(12) Patent Application Publication
(10) Pub. No.: US 2026/0349396 A1
(43) Pub. Date: Nov. 5, 2026

(54) LEARNING DEVICE, CONTROL SYSTEM, LEARNING METHOD, AND RECORDING MEDIUM

(71) Applicants: Shumpei KUBOSAWA, Tsukuba-shi (JP); Takashi ONISHI, Tsukuba-shi (JP); Yoshimasa TSURUOKA, Tsukuba-shi (JP)

(72) Inventors: Shumpei KUBOSAWA, Tsukuba-shi (JP); Takashi ONISHI, Tsukuba-shi (JP); Yoshimasa TSURUOKA, Tsukuba-shi (JP)

(21) Appl. No.: 19/123,616

(22) PCT Filed: Oct. 12, 2023
(86) PCT No.: PCT/JP2023/037089

§ 371 Date: Apr. 23, 2025

(51) Int. Cl. G05B 13/02; G06N 3/092

(52) U.S. Cl. CPC G05B 13/027; G06N 3/092

(57) ABSTRACT

A learning device uses an internal evaluation function in reinforcement learning to determine at least one of an evaluation value for an operation in a state in an environment including a control object or an evaluation value for a next state of the state, and determines an operation relating to the control object on the basis of the determined evaluation value, wherein the internal evaluation function is stipulated so as to generate the evaluation value indicating that the higher a frequency of a state in a desired operation of the control object, the higher an evaluation.

### TECHNICAL FIELD

The present disclosure relates to a learning device, a control system, a learning method, and a recording medium.

### BACKGROUND ART

Reinforcement learning determines the next action to be taken in a certain state based on an evaluation function, and by repeating this process, it searches for a better state and action. The evaluation function in reinforcement learning is defined, for example, to highly evaluate the closeness of the distance between the target state and the detected state, and the effectiveness of learning is improved by repeating trial-and-error calculations based on the results of this evaluation function. Value iteration and policy iteration, known as reinforcement learning techniques, are examples of optimization techniques for searching for optimal solutions.

### PRIOR ART DOCUMENTS

### Patent Documents

Patent Document 1: Japanese Unexamined Patent Application, First Publication No. 2021-030359

### SUMMARY OF INVENTION

### Problems to be Solved by the Invention

However, it can be difficult to define an internal evaluation function that will produce good results in such reinforcement learning.

Therefore, an example of an objective of the present disclosure is to provide a learning device, a control system, a learning method, and a recording medium that can solve the above-mentioned problems.

### Means for Solving the Problem

According to a first aspect of the present disclosure, a learning device is provided with a calculation processing portion that uses an internal evaluation function in reinforcement learning to determine at least one of an evaluation value for an operation in a state in an environment including a control object and an evaluation value for the next state of the state, and determines an operation relating to the control object on the basis of the determined evaluation value, wherein the internal evaluation function is stipulated so as to generate the evaluation value indicating that the higher the frequency of a state in the desired operation of the control object, the higher the evaluation.

According to a second aspect of the present disclosure, a control system is provided with the above-mentioned learning device and a control portion that has undergone offline reinforcement learning by the learning device based on the frequency of the state, wherein the control portion controls the control object using a result of the offline reinforcement learning.

According to a third aspect of the present disclosure, a learning method uses an internal evaluation function in reinforcement learning to determine at least one of an evaluation value for an operation in a state in an environment including a control object and an evaluation value for the next state of the state, and determines an operation relating to the control object on the basis of the determined evaluation value, wherein the internal evaluation function is stipulated so as to generate the evaluation value indicating that the higher the frequency of a state in the desired operation of the control object, the higher the evaluation.

According to a fourth aspect of the present disclosure, a recording medium stores a program for causing a device that executes a program of a learning process related to reinforcement learning to use an internal evaluation function in reinforcement learning to determine at least one of an evaluation value for an operation in a state in an environment including a control target and an evaluation value for the next state of the state, and to determine an operation of the control target based on the obtained evaluation value, and to generate, by the internal evaluation function, the evaluation value indicating that the higher the frequency of a state in a desired operation of the control target, the higher the evaluation.

### Effect of Invention

According to the present disclosure, this specifies an internal evaluation function for achieving good reinforcement learning results.

### BRIEF DESCRIPTION OF DRAWINGS

FIG. 1 illustrates a configuration diagram of a control system 1 according to some example embodiments of the present disclosure.

FIG. 2 illustrates a block diagram of a calculation processing device 10 according to some example embodiments of the present disclosure.

FIG. 3A illustrates a diagram for explaining application examples of some example embodiments of the present disclosure.

FIG. 3B illustrates a diagram for explaining another application example of some example embodiments of the present disclosure.

FIG. 4 illustrates a diagram for explaining making a value function in some example embodiments of the present disclosure a learning target.

FIG. 5 illustrates a diagram for explaining the definition of a “value function” according to some example embodiments of the present disclosure.

FIG. 6 illustrates a diagram for explaining an example of estimating value from a limited number of state-action data according to some example embodiments of the present disclosure.

FIG. 7 illustrates a diagram for explaining a method for approximating a state distribution in some example embodiments of the present disclosure.

FIG. 8 illustrates a diagram for explaining the approximation of a density function according to some example embodiments of the present disclosure.

FIG. 9A illustrates a diagram for explaining a parameter balancing adjustment technique according to some example embodiments of the present disclosure.

FIG. 9B illustrates a diagram for explaining a parameter balancing adjustment technique according to some example embodiments of the present disclosure.

FIG. 9C illustrates a diagram for explaining a parameter balancing adjustment technique according to some example embodiments of the present disclosure.

FIG. 10 illustrates a diagram for explaining the optimization process according to some example embodiments of the present disclosure.

FIG. 11 illustrates a diagram for explaining the gradient of a value function in a state space in some example embodiments of the present disclosure.

FIG. 12 illustrates a diagram for explaining the gradient of a value function in a state space showing the relationship between a parameter Ov and a state s in some example embodiments of the present disclosure.

FIG. 13 illustrates a flowchart for explaining the processing by the calculation processing device according to some example embodiments of the present disclosure.

FIG. 14 illustrates a diagram illustrating an example of a configuration of the calculation processing device according to some example embodiments of the present disclosure.

FIG. 15 illustrates a flowchart illustrating an example of a processing procedure in a computation method according to some example embodiments of the present disclosure.

FIG. 16 illustrates a schematic block diagram illustrating a computer configuration according to some example embodiments of the present disclosure.

### EXAMPLE EMBODIMENTS

Hereinbelow, a computer according to some example embodiments of the present disclosure will be described with reference to the drawings. The following description is for explaining example embodiments of the present disclosure, and the present disclosure is not limited to the following example embodiments. For clarity of explanation, the following description has been omitted and simplified as appropriate. Furthermore, each element of the following example embodiment can be easily modified, added, or converted within the scope of the present disclosure.

Note that the internal evaluation function in reinforcement learning is an example of a function estimated by the reinforcement learning, such as a policy function or value function in reinforcement learning. In the following description, the policy function or value function may be referred to as the internal evaluation function.

The frequency of a state in reinforcement learning refers to the frequency with which a state in a desired operation of a control object occurs in the data used in reinforcement learning in a case where the results of reinforcement learning are used to control the control object. In the following explanation, this is sometimes referred to as experience value.

Trajectory data indicating a frequency distribution is data indicating the frequency of samples or a representative value obtained based on the frequency of samples. For example, the representative value obtained based on the frequency of the samples may be a result that approximates a Gaussian distribution based on the frequency of the samples. In a case where a state in reinforcement learning is used as a sample, the trajectory data indicating the frequency distribution of the state may be data indicating the frequency of the state or a representative value obtained based on the frequency of the state. More specifically, the policy distribution in reinforcement learning may be the probability that action a is selected in state s in a case where the state in reinforcement learning transitions through multiple stages and the state is in state s at a certain stage.

Trajectory data based on conditional probability is data indicating a probability under a specified condition or a representative value obtained based on the probability under a specified condition. For example, the representative value obtained based on the probability under a predetermined condition may be a result that approximates a Gaussian distribution based on the probability under the predetermined condition. The policy function of reinforcement learning may be set based on trajectory data with conditional probabilities depending on the state of the action determined in reinforcement learning.

An expert related to the control of a control object is someone who performs operations related to the control of a control object or someone who determines those operations and determines commands related to that control, and is an example of someone who has sufficient knowledge about operations related to the control of a control object.

FIG. 1 is a block diagram of a control system 1 according to some example embodiments of the present disclosure. The control system 1 controls a plant in real space. For example, the illustrated plant is an example of a chemical plant.

The control system 1 includes a calculation processing device 10 (learning device) and a plant P.

The calculation processing device 10 is provided with, for example, an adjuster 11, a sensor 12, a control portion 13, a memory portion 15, and an input/output portion 16. In addition, either the adjuster 11 or the sensor 12 may be provided as a configuration of the plant P.

The adjuster 11 adjusts the state of the plant P, which is the control object, in accordance with control from the control portion 13.

The sensor 12 detects the state of the plant P and outputs the detection result to the control portion 13.

The memory portion 15 includes a memory area such as a semiconductor memory element, and holds written data.

The input/output portion 16 includes a display unit that displays information and an input device such as a touch panel.

A communication portion 17 provides an interface for communicating with an external higher-level device.

Next, an overview of the operation of the control system 1 according to some example embodiments of the present disclosure will be described.

The control portion 13 controls the plant P as a control object, feeds back a state value (state s) indicating the state of the plant P outputted by the sensor 12, and performs feedback control based on this. This control system 1 receives instructions from a higher-level device (scheduler) to switch control tasks, which changes the control target accordingly. Even in such cases, the purpose of control is to stably and quickly transition to the state indicated by the new control target. The control system 1 can adjust the manipulated variable and generation timing for the plant P in a case where the control target changes in response to switching of the control task.

For example, the control portion 13 adjusts the state of the plant P by controlling the injection amount of the target material by adjusting, for example, the opening degree of a valve, opening and closing of a valve, etc., based on the detection results of the sensor 12.

Incidentally, in a case where an instruction to switch control tasks is received, the control system 1 can adjust the magnitude and occurrence timing of state changes acting on the plant P in a case where the control target changes accordingly.

In addition, the control portion 13 in some example embodiments of the present disclosure is provided with a neural network NN (referred to as the NN of the control portion 13) that undergoes learning to ensure the safety of the plant P that is the control object. The NN of the control portion 13 generates a control amount (action a) for the adjuster 11 based on the state s of the plant P. The state of the plant P includes various data such as the liquid volume, pressure, and concentration detected by the sensor 12. Such a control portion 13 controls the adjuster 11 based on the detection results of the sensor 12.

Next, the configuration of the control portion 13 during learning of the NN and the learning will be described.

The NN of the control portion 13 in some example embodiments of the present disclosure acquires the control rules determined by learning through offline learning before controlling the actual plant P. This allows the control portion 13 to be adjusted to a functioning state.

The learning of the NN in the control portion 13 is carried out by reinforcement learning by the calculation processing device 10. It should be noted that the NN of the control portion 13 does not restrict the acquisition of the vibration control rule after it is applied to the actual plant P, for example, the readjustment of its response characteristics. The calculation processing device 10 in a case where applied to such reinforcement learning is an example of a learning device.

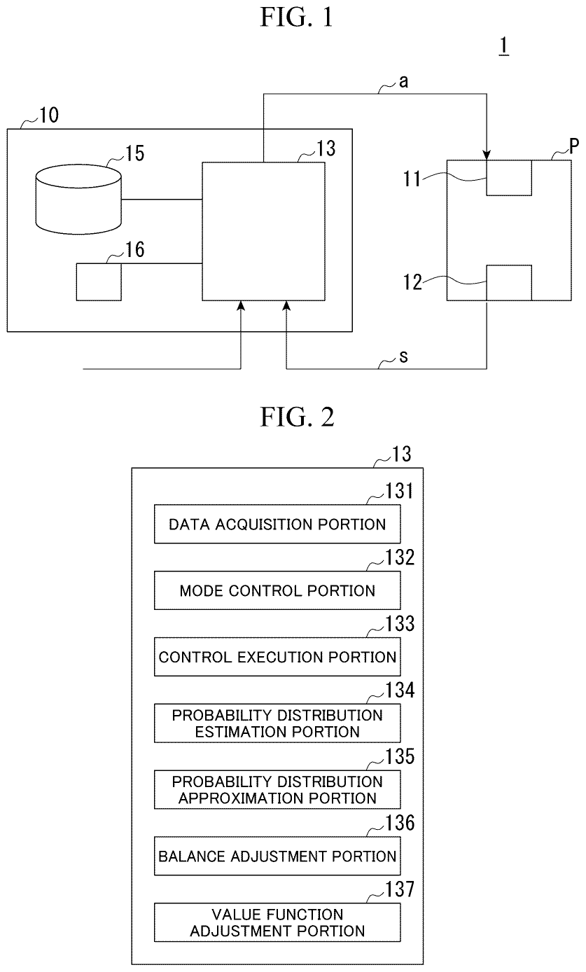

Some example embodiments of the present disclosure will be described with reference to FIG. 2. FIG. 2 is a configuration diagram of a calculation processing device 10 according to some example embodiments of the present disclosure.

The control portion 13 is provided with, for example, a data acquisition portion 131, a mode control portion 132, a control execution portion 133, a probability distribution estimation portion 134, a probability distribution approximation portion 135, a balance adjustment portion 136, and a value function adjustment portion 137.

The data acquisition portion 131 acquires various data from an external source and adds the acquired data to the memory portion 15.

The mode control portion 132 switches to a mode selected from a learning preparation mode, learning mode, and control execution mode as the operating mode that specifies the process to be performed by the control portion 13.

The learning preparation mode provides a state for collecting sample data for offline training and adding it to dataset D.

In the learning mode, a state is provided in which a probability distribution is generated by performing estimation processing based on data, mainly using the collected and accumulated data of the data set D. In this learning mode, processes such as approximating the generated probability distribution and adjusting the value function may be further carried out.

The control execution mode provides a state in which actual control is executed after the learning process in the learning mode is completed.

In a case where the control execution mode is selected, the control execution portion 133 executes actual control of the plant P that is the control object. With this control, the control execution portion 133 acquires a control target from a higher-level device for the plant P that is the control object, and adjusts each unit so as to implement control according to this control target. The control execution portion 133 determines the sequential action at through processing in the control execution mode, and outputs the control amount based on this result. These will be described in more detail below.

The probability distribution estimation portion 134 performs a process of estimating a probability distribution based on the accumulated data of the data set D.

The probability distribution approximation portion 135 generates a transformed probability distribution (second probability distribution) based on the probability distribution generated by the estimation process by the probability distribution estimation portion 134 (first probability distribution). The probability distribution approximation portion 135 may include processing such as nonlinear mapping transformation in the conversion to the second probability distribution.

The balance adjustment portion 136 executes a balance process to prevent bias in the probability distribution estimated by the probability distribution estimation portion 134. More specifically, in a case where a plurality of types of processing are carried out, adjustments are made so that the same processing is not carried out consecutively.

The value function adjustment portion 137 adjusts the gradient of value function V in the state space.

For example, the probability distribution estimation portion 134, the probability distribution approximation portion 135, the balance adjustment portion 136, and the value function adjustment portion 137 are an example of a calculation processing portion that executes the learning process in the learning mode.

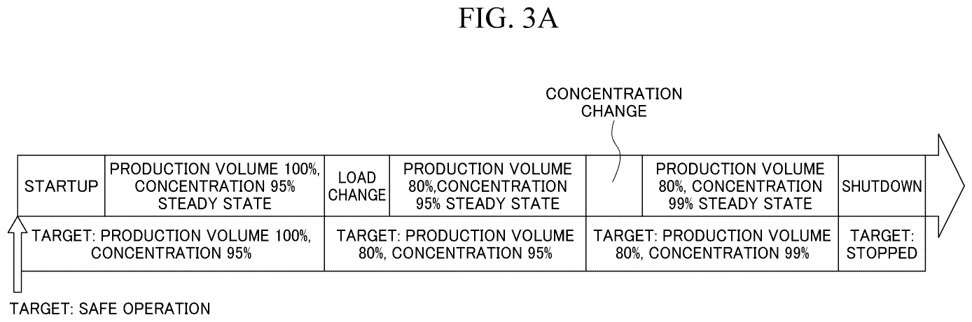

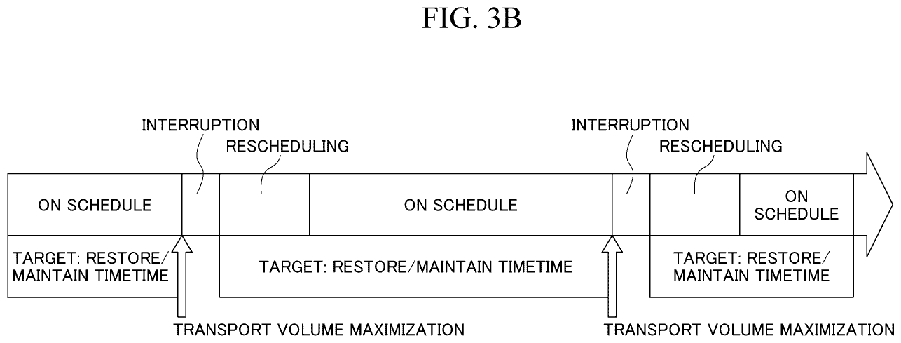

FIG. 3A is a diagram for explaining application examples of some example embodiments of the present disclosure.

The time chart shown in this figure includes control for transitioning from the start of operations (startup) in a chemical plant (Plant P) to a first steady state, control for transitioning from the first steady state via an unsteady state associated with a load change to a second steady state, control for transitioning from the second steady state via an unsteady state associated with a change in concentration designation to a third steady state, and control associated with the suspension of operations (shutdown).

In the first steady state, production is planned with the goal of producing a product with a production volume of 100% and a concentration of 95%. In the second steady state, production is planned with a target production volume of 80% and a product concentration of 95%. In the third steady state, production is planned with a target production volume of 80% and product concentration of 99%. The above target ratios and switching counts are merely examples, and are not limited to these and can be changed as appropriate.

In this way, during each steady state period, a large amount of data distributed around the target value is generated and stored as history data. By repeating such operations, more data is collected and the density of data around the control target in the state space and action space increases.

In this way, by utilizing the distinction between steady state and non-steady state, it becomes possible to classify data based on task switching requests from a higher-level device. In some example embodiments of the present disclosure, in a case where there is a discontinuous interval due to a change in the operation state of the control system 1, it is advisable to divide the interval into several tasks.

In some example embodiments of the present disclosure, in a case where there is a discontinuous section due to a change in the operation state or the like, it is advisable to divide the section into several tasks each corresponding to a single section.

### (on Learning Value Functions)

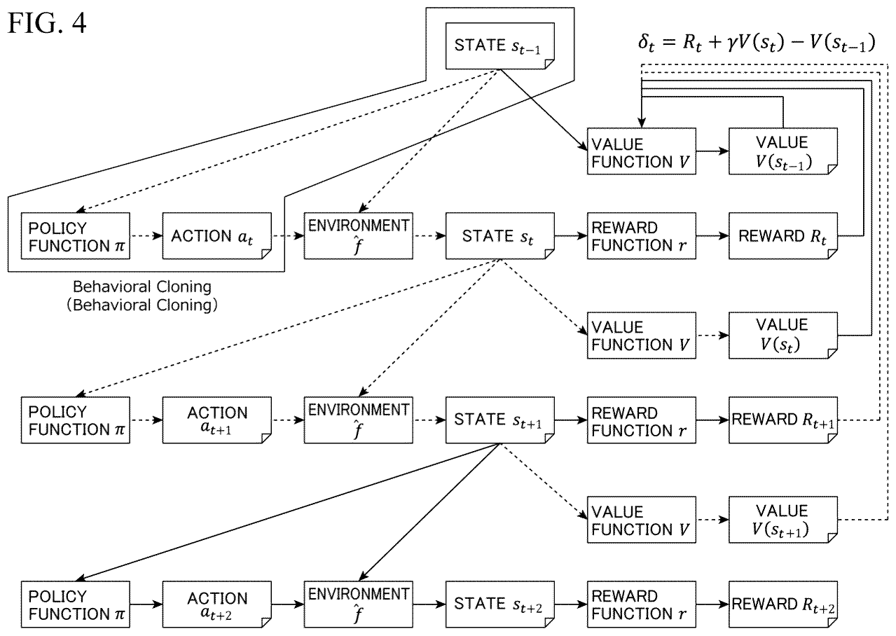

Learning a value function in some example embodiments of the present disclosure will be described with reference to FIG. 4.

FIG. 4 is a diagram for explaining the learning of a value function in some example embodiments of the present disclosure.

This diagram models a typical reinforcement learning procedure.

Assume that events proceed from the top to the bottom of this diagram.

The top row shows “state sₖ₋₁”. This figure shows the state at the oldest time in the history.

In a case where checking the column of “state sₖ₋₁” in this figure from the top, following the topmost “state sₖ₋₁” are “state sₖ”, “state sₖ₊₁”, and “state sₖ₊₂”.

From the left end of the same row as “state sₖ”, the “policy function π”, “action at”, “environment f”, “state s”, “reward function γ”, and “reward Rt” are arranged in this order.

Between the top row and the row for “state sₖ”, “value function V” is arranged, and to the right of this, “value V(sₖ₋₁)” is arranged in series.

“state sₖ₋₁” is related to “value function V”, and “value V(sₖ₋₁)” is generated by “value function V”.

Furthermore, the “state sₖ₋₁” is associated with the “policy function π” and the “environment f”.

Note that the “policy function π” and the “action at” are an example of behavioral cloning.

The same explanation as above can be applied to the other stages.

### (Pre-Training for Value Functions)

In typical reinforcement learning, learning the value function precedes estimating the reward function. For comparison, this is described below.

In the reinforcement learning of the comparative example, learning progresses as follows: state=>reward function=>value function=>policy function (=>action). The value function V(s) of the comparative example is shown in the following Expression (1). The value function V(s) is an example of a state value function (state).

$$[ Expression 1 ]$$

$$V ( s ) = {𝔼}_{( s , a ) ∼ π} [ {\sum }_{t = 0}^{∞} {γ}^{t} r ( s , a ) ] \qquad ( 1 )$$

In the above Expression (1), E_{(s, a)~π[⋅]} represents the value of state s expected under policy π in a case where action a is performed in state s. The figures in [⋅] are cumulative rewards. In this case, the state trajectory is obtained from the result of accumulating the reward at each time t using the calculation result of the reward function r(s, a) for a pair of state s and action a at time t and its discount rate γ. The discount rate Y is a coefficient that estimates the influence of the reward r at each time t, and is, for example, a positive real number equal to or less than 1 (0<γ≤1). By determining this discount rate γ, the influence of rewards expected in the distant future can be adjusted.

For example, trajectory data for the entire range of time t is obtained from the trajectory data for each time t, and a value function V(s) is defined based on the distance to this trajectory data.

According to this Expression (1), the value function V(s) is defined using the reward function r(s, a). Also, according to FIG. 4, it is easier to trace back from the action at to the value function V(s) than from the reward Rt to the value function V(s). In order to define such a relationship as an inverse function, it is easier to find the value function V(s) than the reward function r.

In the database D, information on “state=>action=>next state” for each stage is recorded. The elements of the database D are shown in Expression (2). Identification between each stage may be performed using a identification index “k”.

$$[ Expression 2 ]$$

$${\{ ( {s}_{k} , {a}_{l 𝔠} ) \}}_{k = 0}^{K} \qquad ( 2 )$$

According to this Expression (2), a pair of state s and action a at each stage, or a pair of action a and state s, is associated with each other and recorded as time history information of the stage identified by the identification index “k”.

By arbitrarily selecting a stage (or time) from among the stages of this database D, it is possible to derive the probability of the state at that stage (or time), the transition probability from state s to state s, the probability that action a will be selected in state s, and so on, from the elements of the database D. The probability of the state, the transition probability from state s to state s, and the probability that action a is selected in state s are shown in the following Expression (3).

[Expression 3]

P(s) OR P(sₜ₊₁|sₜ),P(aₜ|sₜ₋₁) (3)

However, it is not easy to comprehensively set the elements of the database D, and there are cases where the elements only cover a small part of the entire selectable space.

The relationship of the state set S-bar of state s-bar actually stored in the database D to the state set S, which represents the selectable state space, is shown in Expression (4) below. In addition, a character with a line added above the character indicates that a “bar” is appended to the character.

The relationship of the action set A-bar of the action a-bar that is actually stored in the database D to the action set A that represents the selectable action space is shown in the following Expression (5).

[Expression 4]

s̅∈S̅⊆S (4)

[Expression 5]

ā∈Ā⊆A (5)

In this way, state s-bar and action a-bar other than the elements recorded as elements of database D are included in state set S and action set A, respectively. If the number of recorded elements is small compared to the number of elements that can be selected from the entire space, the selection of state s and action a will be restricted.

Therefore, the range of the states s and actions a to be selected is expanded to the range of the state set S and the action set A. As a result, if the state s (i.e., s-bar) and the action a (i.e., a-bar) that are not recorded are within the range included in the state set S and the action set A, they can also be used.

Incidentally, if the data to be analyzed is “business data” that is used in business processing, it is unlikely that “poor operation results” will exist in the operation history for the business processing. According to such “business data”, as shown in Expression (6), the probability P(s_{bad}) of state s in which bad behavior a is selected is overwhelmingly smaller than the probability P(s_{good}) of state s in which good behavior a is selected.

[Expression 6]

P(s_{bad})<<P(s_{good}) (6)

However, the state s required for calculating the value function V is not necessarily recorded. For example, in the case of a task with a production volume of 95% or 100%, target state values such as “0.95” or “1.00” are often not recorded.

In contrast, air traffic control systems, which expect no accidents to occur, record almost no collisions and only ideal situations.

### (Definition Using “Policy Function” and Probability)

The following is an explanation of how the “value function” is defined in terms of the “policy function” and probability.

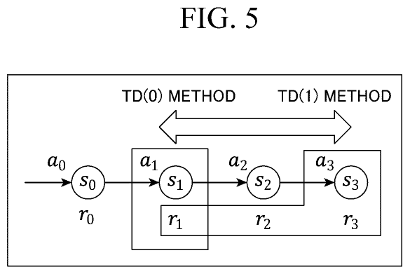

FIG. 5 is a diagram for explaining the definition of a “value function” according to some example embodiments of the present disclosure.

FIG. 5A illustrates an example in which the state transitions from state s₀ to state s₁, s₂, and s₃. In this case, the selected actions a₀, a₁, a₂, and a₃ and the rewards r₀, r₁, r₂, and r₃ obtained in each state are shown.

In the state sₖ, the “value function V” in a case where the policy π is indicated is shown in Expression (7).

$$[ Expression 7 ]$$

$${V}_{π} ( {s}_{k} ) = {𝔼}_{\begin{matrix}{a}_{k : ∞} ∼ {P}_{π} ( {a}_{t} ∣ {s}_{t − 1} ) \\ {s}_{k + 1 : ∞} ∼ {P}_{f} ( {s}_{t + 1} ∣ {s}_{t} , {a}_{t} )\end{matrix}} [ {\sum }_{t = 0}^{∞} {γ}^{t} r ( {s}_{k + t} , {a}_{k + t} ) ] \qquad ( 7 )$$

The right side of this Expression (7) differs from the above Expression (1) in the following respects. For example, action aₖ:∞ denotes actions from the stage identified by the identification information “k” to the future. P_{π}(aₜ|sₜ₋₁) denotes the policy distribution of the probability that action at is performed in state sₜ₋₁ at time t. In other words, the policy distribution represents a frequency distribution based on the frequency of states.

The state s_{k+1:∞} indicate states from the stage identified by the identification information “k+1” to the future. P_{f}(sₜ₊₁|sₜ, aₜ) represents the policy distribution of the probability of reaching state sₜ₊₁ for a pair of state sₜ and action at time t. In other words, this policy distribution indicates a frequency distribution based on the frequency of entering state sₜ₊₁ in a pair of state sₜ and action aₜ.

In the above Expression (7), E[⋅] represents the expected value of state s under the policy π in a case where action a is performed in state s, similar to the above Expression (1). Note that the action a_{k:∞} at time t is determined based on the policy distribution P_{π}(aₜ|sₜ₋₁) at time t. The state s_{k+1:∞} at time t is determined based on the policy distribution P_{f}(sₜ₊₁|sₜ, aₜ).

Based on this condition, the value function V(s) is defined. The details of this are explained below.

In a state sₖ, the next action aₖ to be taken is simply referred to as the “next action aₖ”.

The expected value Q_{π}(sₖ, aₖ) in a case where the actions after the next action aₖ are sampled and selected according to the policy is shown in Expression (8).

$$[ Expression 8 ]$$

$${Q}_{π} ( {s}_{k} , {a}_{k} ) = {𝔼}_{\begin{matrix}{a}_{k + 1 : ∞} ∼ {P}_{π} ( {a}_{t} ∣ {s}_{t − 1} ) \\ {s}_{k + 1 : ∞} ∼ {P}_{f} ( {s}_{t + 1} ∣ {s}_{t} , {a}_{t} )\end{matrix}} [ {\sum }_{t = 0}^{∞} {γ}^{t} r ( {s}_{k + t} , {a}_{k + t} ) ] \qquad ( 8 )$$

Comparing the above Expression (7) and Expression (8), the left sides are different. The following description will be given in order using this Expression (8). Note that the state sₖ and the action aₖ in the reward function r(s, a) on the right-hand side of Expression (8) are variables specified by the identification information “k+t”.

Incidentally, the expected value in a case where the next action aₖ is specified regardless of the policy is shown in Expression (9). In response to this, the second and subsequent terms on the right-hand side are rewritten using the value function V.

[Expression 9]

Q_{π}(sₖ,aₖ)=r(sₖ,aₖ)+γ[r(sₖ₊₁,aₖ₊₁)+γr(sₖ₊₂,aₖ₊₂)+ . . . ]=r(sₖ,aₖ)+γV_{π}(sₖ₊₁) (9)

In a case where comparing this Expression (9) with the expression for the value function V, it can be seen that the first steps shown on the right-hand side are different from each other.

The value function in a case where the next action ax is as per the policy is shown in Expression (10), and similarly the policy function is shown in Expression (11).

$$[ Expression 10 ]$$

$${Q}_{π} ( {s}_{k} , {a}_{k} ) = {P}_{π} ( {a}_{k} \vert {s}_{k} ) ) = {V}_{π} ( {s}_{k} ) \qquad ( 10 )$$

$$[ Expression 11 ]$$

$${P}_{π} ( a \vert {s}_{k} ) : = \frac{exp ( {Q}_{π} ( {s}_{k} , a ) )}{{\sum }_{{a}_{i} ∈ A} exp ( {Q}_{π} ( {s}_{k} , {a}_{i} ) )} = \frac{exp ( {Q}_{π} ( {s}_{k} , a ) )}{{\sum }_{{a}_{i} ∈ A} exp ( r ( {s}_{k} , {a}_{i} ) + γ {V}_{π} ( {s}_{k + 1} ) )} \qquad ( 11 )$$

Here, for example, instead of Expression (10) for estimating the value function from the data of dataset D, the above relationship may be regarded as Expression (12) since the value of the reward is unknown. In other words, the policy distribution can be viewed as a normalized Q function. The softmax term in Expression (12) is intended to normalize the expected cumulative reward. Q_{π}(sₖ, a) on the left side of Expression (12) is an example of a state-action value function Q (state, action) in reinforcement learning. P_{π}(a|sₖ) on the right-hand side of Expression (12) is an example of a policy distribution P(action|state) in reinforcement learning. The policy distribution P(action|state) is the probability that, as the state transitions through multiple stages, the state is in state s at a certain stage k, for example, and that action a is selected in that state s.

[Expression 12]

Q_{π}(sₖ,a)=r(sₖ,aₖ)+γV_{π}(sₖ₊₁)=P_{π}(a|sₖ) (12)

In this way, you can think of regularization as being needed because the reward function does not take regularization into account. The results of these studies led to the following policy (Policy 1).

Policy 1: “Consider the policy distribution of offline data as a Q function”.

In other words, the policy distribution P_{π}(a|sₖ) of reinforcement learning shown in Expression (12) is the probability that action a is selected in a certain state sₖ as the state transitions through multiple stages. This relationship is shown in the following Expression (13).

[Expression 13]

Q_{π}(sₖ,a):=P_{π}(a|sₖ) (13)

If the number of data registered in dataset D is small, it may be advisable to consider methods such as adding noisy data as data in dataset D, or adding data with noise added to normal value data as data in dataset D.

For example, in a case where estimating the distribution of the value function and the policy function, the control portion 13 may add noise to either or both of the state and the action, and apply regularization that reduces the frequency of states to which noise has been added or actions to which noise has been added.

(Method of Estimating Value from Limited State-Action Data)

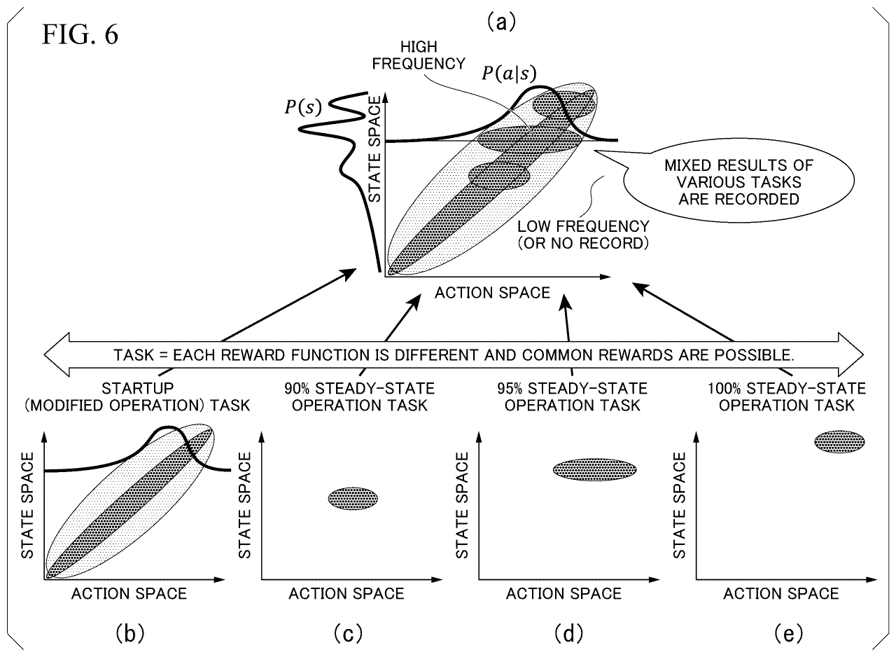

Next, with reference to FIG. 6, a case where value is estimated from a limited number of state-action data will be described. FIG. 6 is a diagram for explaining an example of estimating value from a limited number of state-action data according to some example embodiments of the present disclosure.

Policy 2: “Consider the policy distribution of offline data as a Q function”.

That is, the state value function V(state) of reinforcement learning is set using the TD (Temporal Difference) error of reinforcement learning.

This relationship is shown in the following Expression (14). In V(s) of Expression (14), for example, V(sₖ) in a case where state s is identified by identification information “k” is an example of a state value function V(state) in state sₖ.

[Expression 14]

V(s):=P(s) (14)

For example, in a case where a target system is applied to a specific business, the usage pattern will have small variations in the observed state s and selected action a.

In (a) of FIG. 6, the state-action data is allocated to a two-dimensional plane having the components of the action space and the state space as axes. (b) of FIG. 6 shows the distribution during the startup task and the modified operation task at startup. (c) of FIG. 6 shows the distribution during 90% steady-state operation. (d) of FIG. 6 shows the distribution during 95% steady-state operation. (e) of FIG. 6 shows the distribution during 100% steady-state operation.

The axes of each diagram in FIG. 6 are common, with the distribution of the action space being assigned to the horizontal axis and the distribution of the state space being assigned to the vertical axis. The distributions shown in each of these figures are distributions for two-dimensional planes of action space and state space.

In a case where it comes to “business data” for such purposes, there will be a lot of records of data being manipulated properly. And there should be few records of poorly manipulated systems. Therefore, the results obtained in the figure tend to show a highly correlated distribution. As described above, different operation conditions (types of tasks) result in different distribution trends.

Also, as noted above, the state probability P(s) may not be strictly Gaussian. In such a case, for example, it is advisable to divide the range of analysis in the time axis direction and separate different types of work (tasks), thereby reducing the variance in the observed states sₖ and selected actions aₖ. Separating different types of work (tasks) from one another is an example of dividing a task.

Alternatively, it is advisable to determine whether the data distribution can be regarded as a Gaussian distribution or a mixed Gaussian distribution. If it is possible to consider it in the above manner, this should be followed.

If it is difficult to make the above-mentioned assumption, it is advisable to use an autoencoder or the like to nonlinearly map the original data and determine whether it is possible to make the data be considered to have a Gaussian distribution in the mixed space generated by this mapping. If a desired distribution can be obtained by using such a nonlinear mapping, it is advisable to use this.

However, if the performance of individual tasks is unknown, classification associated with individual tasks may also be difficult.

For example, each task that specifies a control target is executed so as to perform specialized operations such as “normal operation at 95% production volume” and “changed operation to 100% production volume”. Even for tasks under such conditions, target values for individual tasks are often not recorded as additional information to the data. Therefore, it is difficult to classify the performance of each task.

In response to this, classification becomes easier by associating and recording information that can identify the location where a task is switched or information that enables classification of each task. It is advisable to use classification rules applicable to such classification. If such classification-facilitating information is not available, clustering may be based on state distributions.

In the above method, for example, in a case where the frequency distribution shows a Gaussian distribution or can be regarded as a Gaussian distribution, the frequency distribution may be regarded as a value. This will be explained below.

More specifically, as shown in Expression (15), the distribution of the Q function is considered to follow the policy distribution. Also, as shown in Expression (16), it is assumed that the distribution of value follows the distribution of the value function. V(sₖ) in the case where state s in Expression (16) is identified by identification information “k” is an example of a state value function V(state) in reinforcement learning.

[Expression 15]

Q_{π}(sₖ,a):=P_{π}(a|sₖ) (15)

[Expression 16]

V_{π}(sₖ):=P_{π}(sₖ) (16)

The above Expression (15) is derived from the previously mentioned expressions (8) and (9).

The right side of Expression (15) may be approximated as a probability distribution determined for each state sₖ. An example of this is shown in the following Expression (17).

[Expression 17]

[symbol]

(μ_{π}(sₖ),σ_{π}(sₖ)) (17)

This is because the estimation error may increase if the denominator and numerator on the right side of the above-mentioned Expression (15) are calculated separately.

Furthermore, in the optimal solution of the Q function, the relationship in the following Expression (19) can be derived by utilizing the precondition shown in the following Expression (18).

[Expression 18]

P_{π}(a|sₖ)=r(sₖ,aₖ)+γP_{π}(sₖ₊₁) (18)

[Expression 19]

r(sₖ,aₖ)= [symbol] ₛ_{ₖ₊₁}_{~P}_{_{f}}₍ₛ_{ₖ₊₁}_{|s}_{ₖ}_{,a}_{ₖ}₎[P_{π}(aₖ|sₖ)−γP_{π}(sₖ₊₁)] (19)

The contents of the brackets on the right side of this Expression (19) can be calculated from the instance (sₖ, aₖ, sₖ₊₁). Note that the possible values of Expression (19) are restricted to the following Expression (20).

[Expression 20]

−γ≤r(sₖ,aₖ)≤1 (20)

### (Distribution Estimation Method)

Next, the estimation of the policy distribution and the distributions of the value and reward functions shall be described.

As input information, a data set D and a discount rate γ (0<γ<1) are used.

As output information, the policy distribution and the distributions of the value function and reward function are output.

First, the policy distribution and the value function distribution are fitted from the data.

The distribution of the reward function is calculated from the data extracted from the dataset D (see Expression (21)) using the following Expression (22), which is recorded and then fitted.

[Expression 21]

(sₖ,aₖ,sₖ₊₁)∈D

DATASET D={s₀,a₀,s₁,a₁,s₂,a₂, . . . ,sₖ₋₁,aₖ₋₁,sₖ,aₖ,sₖ₊₁,aₖ₊₁, . . . } (21)

[Expression 22]

r(sₖ,aₖ)=P(aₖ|sₖ)−γP(sₖ₊₁) (22)

Note that a feature of some example embodiments of the present disclosure is the use of the following Expression (23). The TD error δ in this case is given by Expression (24), and by using this, the above Expression (23) is converted to Expression (25).

The ideal policy A_{π} is given by the following Expression (26), which can be calculated using the value of the Q function.

[Expression 23]

A_{π}(sₖ,aₖ)=Q_{π}(sₖ,aₖ)−V_{π}(sₖ) (23)

[Expression 24]

δ(sₖ,aₖ)=r(sₖ,aₖ)+γV_{π}(s_{kL1})−V_{π}(sₖ) (24)

[Expression 25]

A_{π}(sₖ,aₖ)=Q_{π}(sₖ,aₖ)−V_{π}(sₖ)=r(sₖ,aₖ)+γV_{π}(sₖ₊₁)−V_{π}(sₖ) (25)

[Expression 26]

A_{π}(sₖ,aₖ)=δ(sₖ,aₖ) (26)

### (Approximation Method of State Distribution)

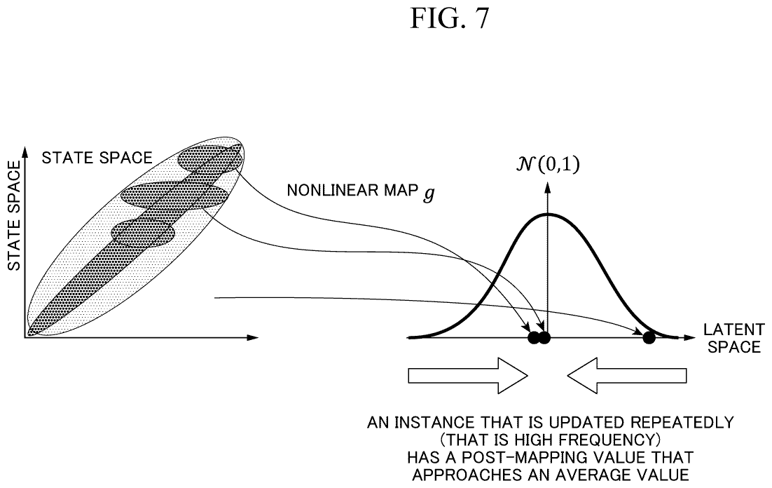

The approximation method of the state distribution will be described with reference to FIG. 7.

FIG. 7 is a diagram for explaining a method for approximating a state distribution in some example embodiments of the present disclosure.

The approximation method of the state distribution shown here is such that the distribution in the latent space becomes a Gaussian distribution or a mixture of Gaussian distributions by nonlinear mapping from the state space.

The nonlinear mapping nonlinearly maps from the state space to the one-dimensional latent space R. This mapping is shown in Expression (27). The distribution in the latent space is represented by a probability value ranging from 0 to 1, assuming that it is, for example, a standard normal distribution N(0,1). For example, the distribution is shown in Expression (28).

[Expression 27]

gᵤ:S→ [symbol] (27)

[Expression 28]

Pₛ(s∈S)= [symbol] (0,1) (28)

The following is an example of a method for approximating the state distribution.

First, the parameter u of the nonlinear mapping g is updated using the gradient ascent method or the like to approximate the distribution.

The gradient ascent method is shown in the following Expression (29). This instance is equivalent to minimizing Expression (30). This minimization relationship is shown in Expression (31).

$$[ Expression 29 ]$$

$$u ← u + η \frac{\partial {P}_{s} ( {s}_{t} )}{\partial u} \qquad ( 29 )$$

$$[ Expression 30 ]$$

$$- ∞ \leq log {P}_{s} ( {s}_{t} ) \leq 0 THAT IS 0 \leq log {P}_{S} ( {s}_{t} ) \leq ∞ ( ENERGY ) \qquad ( 30 )$$

$$[ Expression 31 ]$$

$$ℒ ( θ ) = \frac{1}{N} {\sum }_{i = 1}^{N} log {P}_{s} ( {s}_{i} ; θ ) \qquad ( 31 )$$

An approximation method using a nonlinear mapping g has been described. Furthermore, we may add autoencoder constraints to the dimensionality reduction. This restriction can be added or removed at will.

With an autoencoder, this preserves state features even in low-dimensional spaces. The “closeness of the state” is memorized by learning the nonlinear mapping g.

An example of an autoencoder is shown in Expression (32).

$$[ Expression 32 ]$$

$$ℒ ( θ ) = - γ \frac{1}{N} {\sum }_{i = 1}^{N} log {P}_{s} ( {s}_{i} ; θ ) + \frac{1}{N} {\sum }_{i = 1}^{N} L ( {s}_{i} , \hat{{s}_{i}} ) \qquad ( 32 )$$

$$WHERE$$

$$L ( {s}_{i} , {\hat{s}}_{i} ) = {‖ {s}_{i} , {\hat{s}}_{i} ‖}_{2}^{2} IS A RECONSTRUCTION ERROR$$

(in a Case where Applying the Policy Gradient Method to the Policy Distribution)

In a case where applying the policy gradient method to the policy distribution, it may not be possible to set valid values for the coefficients in the computational formula of the policy gradient method. The computational formula for the policy gradient method is shown in Expression (33). This corresponds to a case where the value of the coefficient A in this expression is, for example, 1.

[Expression 33]

θ←θ+ηA∇_{θ}log π(s,a) (33)

In such a case, it is advisable to add noise to the data set D. The probability value of this noise can be defined by Expression (34).

$$[ Expression 34 ]$$

$$u ← u - η \frac{\partial {P}_{s} ( {s}_{n o i s e} )}{\partial u} \qquad ( 34 )$$

It is advisable to set the probability value of the noise to a small value.

For example, to add noise sₙₒᵢₛₑ to the vicinity of a recorded state sₜ, the state sₜ is used and a noise & is added to it to add noise sₙₒᵢₛₑ based on the state sₜ. This noise sₙₒᵢₛₑ is shown in Expression (35).

[Expression 35]

sₙₒᵢₛₑ=sₜ+ϵ (35)

In this case, since the noise sₙₒᵢₛₑ exists in the vicinity of the state sₜ, the influence of the noise sₙₒᵢₛₑ is relatively small in an area where the state sₜ is concentrated and the density is relatively high. In contrast, in the peripheral region of the state sₜ where the density of the state sₜ is relatively low, the effect of noise sₙₒᵢₛₑ becomes relatively large.

To adjust for such differences in influence, it is advisable to use either or both of the S/N ratio (see Expression (36)) and the noise width σ² (see Expression (37)) as hyperparameters to limit the S/N ratio to within a predetermined range.

$$[ Expression 36 ]$$

$$S / N RATIO \frac{\vert {s}_{t} \vert}{\vert {s}_{noise} \vert} \qquad ( 36 )$$

$$[ Expression 37 ]$$

$$THE NOISE WIDTH {σ}^{2} ( HOWEVER ϵ ∼ 𝒩 ( {s}_{t} , {σ}^{2} ) ) \qquad ( 37 )$$

The kernel density estimation is considered to be a neural approximation.

The calculation expression for kernel density estimation is shown in Expression (38). An example of the kernel function at this time is shown in Expression (39).

$$[ Expression 38 ] \qquad ( 38 )$$

$$The KERNEL DENSITY ESTIMATION = \hat{{f}_{h}} ( s ) = \frac{1}{Nh} {\sum }_{i - 1}^{N} K ( \frac{s - {s}_{i}}{h} )$$

$$[ Expression 39 ]$$

$$The KERNEL FUNCTION IS K ( x ) = \frac{1}{\sqrt{2 π}} exp ( - \frac{{x}^{2}}{2} ) \qquad ( 39 )$$

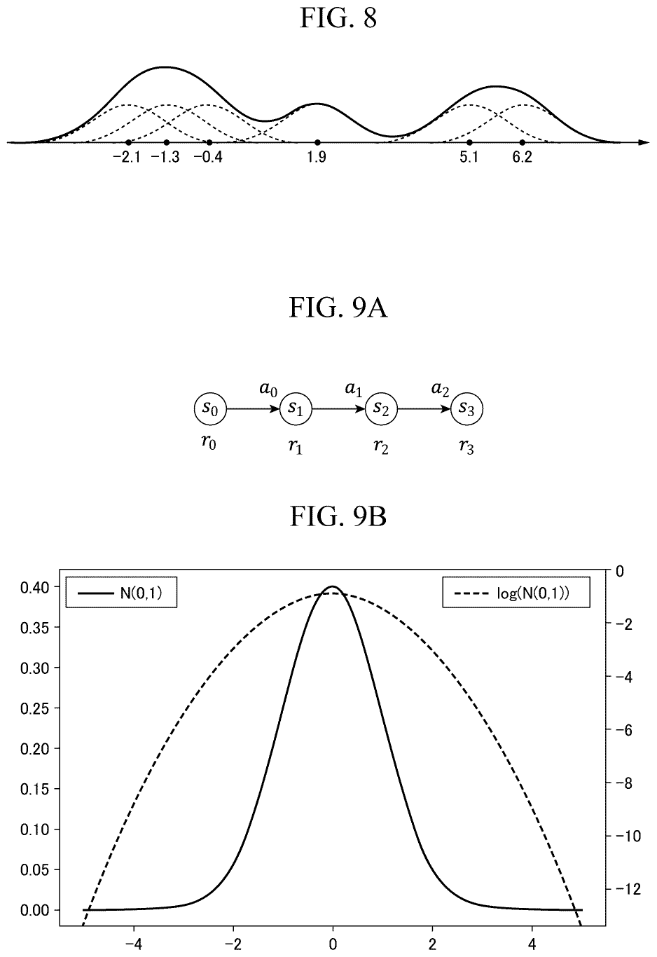

FIG. 8 shows an example of approximating a density function by holding the sample instances shown in Expression (40). FIG. 8 is a diagram for explaining an approximation of a density function according to some example embodiments of the present disclosure.

[Expression 40]

THE SAMPLE INSTANCES {s₁,s₂, . . . ,s_{N}} (40)

For example, for one instance sᵢ, u is updated once by the operation of Expression (41). In this case, it is assumed that one kernel is added. However, the impact of one added instance sᵢ may not be uniform.

The amount of change in the output of each function per update will differ depending on the model and the current parameters.

$$[ Expression 41 ]$$

$$The KERNEL FUNCTION IS K ( x ) = \frac{1}{\sqrt{2 π}} exp ( - \frac{{x}^{2}}{2} ) \qquad ( 41 )$$

(about Behavioral Cloning Using Commercial Dataset D)

The evaluation criterion for reward r is defined using the following Expression (42).

The reward r is converted into a real number set R formed by the product of the state set S and the action set A. The value function V_{π}(sₖ), the value Q_{π}(sₖ, aₖ) of the Q-function (referred to as Q-function), and the TD error δ (referred to as TD-error) are shown.

In addition, in a case where the TD error δ is optimized to be 0, the value function V_{π}(sₖ) can be approximated using the following expression.

$$[ Expression 42 ]$$

$$Reward r : S \times A \to ℝ , V alue {V}_{π} ( {s}_{k} ) = {\sum }_{{a}_{k : ∞} ∼ {P}_{π}} [ {\sum }_{f = 0}^{∞} {γ}^{t} r ( {s}_{k + t} , {a}_{k + t} ) ] \qquad ( 42 )$$

$$Q - function {Q}_{π} ( {s}_{k} , {a}_{k} ) = {\sum }_{{a}_{k + 1 : ∞} ∼ {P}_{π}} [ {\sum }_{t = 0}^{∞} {γ}^{t} r ( {s}_{k + t} , {a}_{k + t} ) ] , {Q}_{π} ( {s}_{k} , {a}_{k} ) = r ( {s}_{k} , {a}_{k} ) + γ {V}_{π} ( {s}_{k + 1} )$$

$$TD - error δ = r ( {s}_{r} , {a}_{t} ) - {V}_{π} ( {s}_{t} ) + γ {V}_{π} ( {s}_{t + 1} ) , If value is optimal δ = 0 ⇒ {V}_{π} ( {s}_{k} ) = r ( {s}_{k} , {a}_{k} ∼ {P}_{π} ( {a}_{k} \vert {s}_{k} ) ) + γ {V}_{π} ( {s}_{k + 1} )$$

The optimal run-time policy is determined using the Q function.

For example, the policy function P_{π}(aₜ|sₜ) used at execution time is shown in Expression (43). If the Q function is normalized, then the policy function P_{π}(aₜ|sₜ) is defined using the normalized Q function values Q_{π}(sₖ, aₖ). The values Q_{π}(sₖ, aₖ) of the Q function ranges from 0 to 1. The sum of the values Q_{π}(sₖ, aₖ) of the Q function is one. In such a situation, we can use approximate rewards and γ.

$$[ Expression 43 ]$$

$${P}_{π} ( {a}_{t} \vert {s}_{t} ) : = \frac{exp ( {Q}_{π} ( {s}_{r} , {a}_{t} ) )}{{\sum }_{{a}_{i} ∈ A} exp ( {Q}_{π} ( {s}_{t} , {a}_{i} ) )} , If Q - function is already normalized , then {P}_{π} ( {a}_{t} \vert {s}_{t} ) = {Q}_{π} ( {s}_{t} , {a}_{t} ) . \qquad ( 43 )$$

$$Q - function is normalized {iff Q}_{π} ( {s}_{k} , a ) ∈ [ 0 , 1 ] and {\sum }_{{a}_{i} ∈ A} {Q}_{π} ( {s}_{k} , {a}_{i} ) = 1. The situation is possible using appropriate reward and γ .$$

In the case of the commercial data set D mentioned above, it is expected that there will be a relatively large number of actions and states contained therein, which are empirical values, in which the correct action was selected and the result was a transition to a good state. Therefore, the frequency of actions and states may be considered desirable.

It is desirable that the following probabilities are proportional. For example, the policy function P_{π}(aₜ|sₜ), the value function V_{π}(sₖ), and the state function P(sₜ) may be proportional to each other.

Based on the above, the reward r(Sₜ, aₜ) is shown in the following Expression (44).

[Expression 44]

r(sₜ,aₜ)=Q_{π}(sₜ,aₜ)−γV_{π}(sₜ₊₁)=P(aₜ|sₜ)−γP(sₜ₊₁) (44)

The policy function P_{π}(aₜ|sₜ) and state function P(sₜ₊₁) in the above Expression (44) can be approximated using the elements of the data set D as described above. This allows the reward r(Sₜ, aₜ) to be predicted using Expression (44).

### (PROCESSING BALANCING CONTROL)

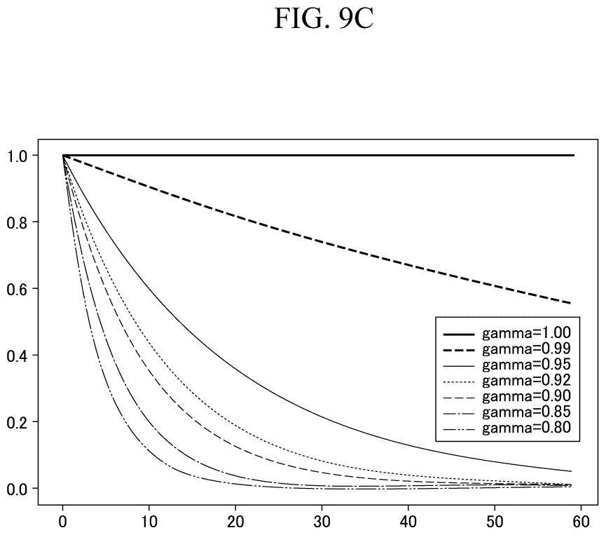

Referring to FIGS. 9A-9C, a process balancing adjustment technique will be described.

FIGS. 9A to 9C are diagrams for explaining an adjustment technique for balancing the process.

FIG. 9A illustrates an example in which the state transitions from state s₀ to state s₁, s₂, and s₃. In this case, the selected actions a₀, a₁, and a₂ and the rewards r₀, r₁, r₂, and r₃ obtained in each state are shown.

The graph shown in FIG. 9B illustrates an example of a probability distribution. Two distributions are shown in this graph. The first graph is for the case where the samples are relatively dispersed, and the second graph is for the case where the samples are relatively concentrated. Some example embodiments of the present disclosure utilize distribution trend features in this manner. In a case where the samples are relatively concentrated as in the second graph, the distribution makes it easy to find the median or central value.

The graph shown in FIG. 9C indicates how much future reward r is discounted depending on the value of the discount rate γ (denoted as gamma in FIG. 9C). The discount rate γ shown here defines seven stages from 1 to 0.8. For example, in a case where the discount rate γ is 1, there is no discount and the graph shows a substantially horizontal line. On the other hand, in a case where the discount rate γ is smaller than 1, the amount to be discounted is determined by the magnitude of the discount rate γ.

In order to balance the calculation of the value V and the reward r, for example, the following estimation process is performed alternately. This allows obtaining suitable parameters. The first estimation process is a process related to estimating a reward value, and the second estimation process is a process using a TD (Temporal Difference) error, for example, a process for minimizing a specified TD error. This optimization process is not limited to minimization, and may be maximization process depending on the arithmetic expression used. The following explains each in order.

### Reward Value Estimation:

Estimating the reward value involves a process of estimating a probability distribution. In estimating the reward value, it is preferable to minimize the sample energy of the distribution function.

The calculation expression for deriving the value of the Q function is shown in Expression (45).

θ_{π} in Expression (45) is defined as in Expression (46).

$$[ Expression 45 ]$$

$${Q}_{π} ( {s}_{t} , {a}_{t} ) : = {P}_{{θ}_{π}} ( {a}_{t} \vert {s}_{t} ) ≃ π ( {s}_{t} , {a}_{t} ; {θ}_{π} ) \qquad ( 45 )$$

$$[ Expression 46 ]$$

$${θ}_{π} = arg {min}_{{θ}_{π}} [ - \frac{1 - λ}{{K}_{p}} {\sum }_{( {s}_{t} , {a}_{t} ) ∈ {D}_{p}} log π ( {s}_{t} , {a}_{t} ; {θ}_{π} ) + \frac{λ}{{K}_{n}} {\sum }_{( {s}_{t ,} {a}_{t} ) ∈ {D}_{n}} log π ( {s}_{t} , {a}_{t} ; {θ}_{π} ) ] \qquad ( 46 )$$

In the above expression, Dₚ denotes a set of positive column samples that are samples recorded in the data set D, and Dₙ denotes a set of negative column samples that are samples not recorded in the data set D. Kₚ is the number of positive column samples (positive column sample number), Kₙ is the number of negative column samples (negative column sample number), and λ is the negative column ratio, which takes a value from 0 to 1. The values of the above variables may be determined appropriately. As an example, the number of positive column samples Kₚ and the number of negative column samples Kₙ may be set to the same number, and the negative column ratio λ may be set to 0.5.

### Minimizing TD Error:

The reward value r is calculated from the current value of the Q function and the value of the value function V using the above Expression (44). The result of this calculation is treated as a constant.

For example, a case where the state transitions from state s₀ to state s₃ in aₜ least three state transitions shown in FIG. 9A will be illustrated. In this case, the result obtained from the evaluation expression (Expression (47)) aₜ the final step (t=3) is minimized.

[Expression 47]

[V(s₃)−r₃]²+[V(s₂)−(r₂+γr₃)]²+[V(s₁)−(r₁+γr₂+γ²r₃)]²+[V(s₀)−(r₀+r₁+γ²r₂+γ³r₃)]² (47)

This Expression (47) becomes the constraint that balances the value V and the reward γ.

The value V(sₜ₊₁) or the correct value of the above Expression (47) is treated as a constant, and the result obtained from the next evaluation expression (Expression (48)) is minimized.

[Expression 48]

[Q(s₂,a₂)−(r₂+γV(s₃))]²+[Q(s₁,a₁)−(r₁+γV(s₂))]²+[Q(s₀,a₀)−(r₀+γV(s₁))] (48)

This Expression (48) becomes the constraint that balances the value of the value V and the value of the Q function.

### (Optimization Process)

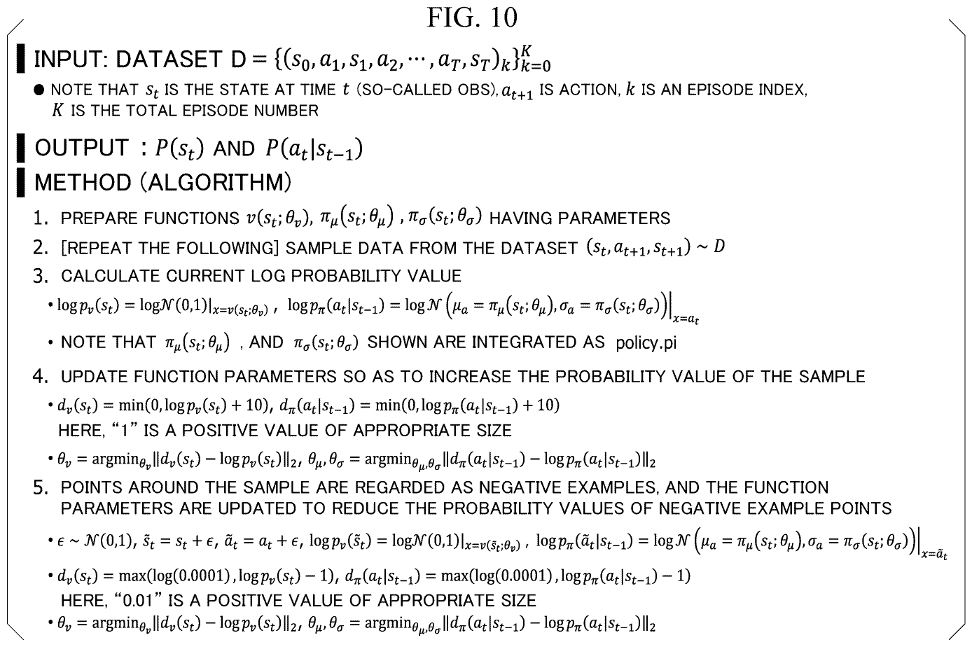

The optimization process of some example embodiments of the present disclosure will be described with reference to FIG. 10.

FIG. 10 is a diagram for explaining the optimization process of the present example embodiment.

The input of this optimization process is a data set D (data set D={(s₀, a₁, s₁, a₂, . . . , a_{T}, s_{T})ₖ}^{K}ₖ₌₀). This data set D includes state and action data for a total number of episodes K. Each episode is identified by an episode index k. sₜ is the state aₜ time t. aₜ₊₁ is the action selected in a case where in state sₜ at time t.

The output of this optimization process is the state probability P(sₜ) and the action probability P(aₜ|sₜ₋₁) shown in Expression (49).

An example of the algorithm for this optimization process is shown below.
(1) Prepare functions with parameters (Expression (49)).
(2) Sample a set of data from dataset D. This process is shown in Expression (50).

[Expression 49]

v(sₜ;θᵥ),π_{μ}(sₜ;θ_{μ}),π_{σ}(sₜ;θ_{σ}) (49)

[Expression 50]

(sₜ,aₜ₊₁,sₜ₊₁)~D (50)

It is advisable to use the action aₜ₊₁ obtained from the above sample as the output for control.
(3) The current log probability value is calculated using Expression (51).

$$[ Expression 51 ]$$

$$log {p}_{v} ( {s}_{t} ) = log 𝒩 ( 0 , 1 ) {\vert}_{x = v ( {s}_{t} ; {θ}_{v} )} , \qquad ( 51 )$$

$$log {p}_{π} ( {a}_{t} \vert {s}_{t - 1} ) = log 𝒩 ( {μ}_{a} = {π}_{μ} ( {s}_{t} ; {θ}_{μ} ) , {σ}_{a} = {π}_{σ} ( {s}_{t} ; {θ}_{σ} ) ) {\vert}_{x = {a}_{t}}$$

Note that the policy π in the above Expression (51) includes the policies π_{μ} and π_{σ} shown in Expression (52).

[Expression 52]

π_{μ}(sₜ;θ_{μ}) AND π_{σ}(sₜ;θ_{σ}) (62)
(4) Update the function parameters to increase the probability value of the sample.

For example, the function parameters include dᵥ(sₜ), d_{π}(aₜ|sₜ₋₁), θᵥ, and θ_{μ}, θ_{σ} shown in Expression (53).

$$[ Expression 53 ]$$

$${d}_{v} ( {s}_{t} ) = min ( log {p}_{v} ( {s}_{t} ) + 10 ) , {d}_{π} ( {a}_{t} \vert {s}_{t - 1} ) = min ( 0 , log {p}_{π} ( {a}_{t} \vert {s}_{t - 1} ) + 10 ) \qquad ( 53 )$$

$$HERE , ⌈ 1 ⌋ IS A POSITIVE VALUE OF APPROPRIATE SIZE$$

$${θ}_{v} = arg {min}_{{θ}_{v}} {‖ {d}_{v} ( {s}_{t} ) \to log {p}_{v} ( {s}_{t} ) ‖}_{2} , {θ}_{μ} {θ}_{σ} = arg {min}_{{θ}_{μ} {θ}_{σ}} {‖ {d}_{π} ( {a}_{t} \vert {s}_{t - 1} ) - log {p}_{π} ( {a}_{t} \vert {s}_{t \to 1} ) ‖}_{2}$$

(5) Points around the sample are regarded as negative examples, and the function parameters are updated to reduce the probability values of negative example points, as shown in Expression (54).

$$[ Expression 54 ]$$

$$ϵ ∼ 𝒩 ( 0 , 1 ) , {\tilde{s}}_{t} = {s}_{t} + ϵ , {a}_{t} = {a}_{t} + ϵ , log p ( {\tilde{s}}_{t} ) = log 𝒩 ( 0 , 1 ) {\vert}_{x = v ( {\tilde{s}}_{t} ; {θ}_{v} )} , log {p}_{π} ( {\tilde{a}}_{t} \vert {s}_{t = 1} ) = log 𝒩 ( {μ}_{a} = {π}_{μ} ( {s}_{t} ; {θ}_{μ} ) , {σ}_{a} = {π}_{μ} ( {s}_{t} ; {θ}_{σ} ) ) {\vert}_{x = {\tilde{a}}_{t}} \qquad ( 54 )$$

$${d}_{v} ( {s}_{t} ) = max ( log ( 0.0001 ) , log {p}_{v} ( {s}_{t} ) - 1 ) , {d}_{π} ( {a}_{t} \vert {s}_{t - 1} ) = max ( log ( 0.0001 ) , log {p}_{π} ( {a}_{t} \vert {s}_{t - 1} ) - 1 )$$

$$HERE , ⌈ 0.01 ⌋ IS A POSITIVE VALUE OF APPROPRIATE SIZE$$

$${θ}_{v} = arg {min}_{{θ}_{v}} {‖ {d}_{v} ( {s}_{t} ) - log {p}_{v} ( {s}_{t} ) ‖}_{2} , {θ}_{u} , {θ}_{σ} = arg {min}_{{θ}_{u} , {θ}_{σ}} {‖ {d}_{π} ( {a}_{t} \vert {s}_{t = 1} ) - log {p}_{π} ( {a}_{t} \vert {s}_{t = 1} ) ‖}_{2}$$

Repeat steps (2) to (5) above.

### (on the Gradient of the Value Function in State Space)

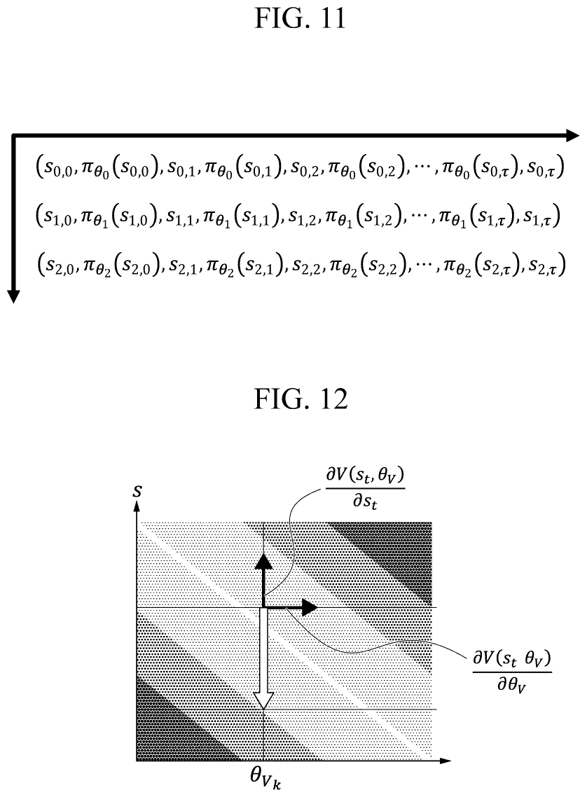

The gradient of the value function in the state space will be described with reference to FIGS. 11 and 12.

FIG. 11 is a diagram for explaining the gradient of a value function in a state space in some example embodiments of the present disclosure.

As shown in FIG. 11, the state s and the policy n are mapped onto a two-dimensional plane including a time axis t (horizontal axis) in the environment and an axis indicating the update history. The data sequence for state s and policy π shown at the top of this two-dimensional plane is for in a case where the update history index is 0, the data sequence in the next row is for in a case where the update history index is 1, and the data sequence in the next row is for in a case where the update history index is 2. The update history index is 0, 1, 2, and so on. As the value increases, it indicates that updates have been repeated.

In the above single data string, states s and strategies π are arranged alternately. The horizontal axis indicates that time t has passed as it moves to the right. The time axis may be defined from the origin 0 to an arbitrary time t.

For example, “state s_{0, 0}” shown on the left side of the top row indicates the state in a case where the update history is 0 and the time t is 0, and “state s_{1, 0}” shown on the left side of the next row indicates the state in a case where the update history is 1 and the time t is 0.

The second from the left in the top row, “policy π_{θ0}(s_{0, 0})”, indicates the value of the policy function in state s_{0, 0} at time t=0 with an update history of 0 and the parameter θ0, while the fourth from the left, “policy π_{θ0}(s_{0, 1})”, indicates the value of the policy function in state s_{0,1} at time t=1 with an update history of 0 and the parameter θ0. The same applies below.

The gradient of the value function V in the state space is determined using the value function and an inverse model.

The process of obtaining the gradient of the value function V using this value function V and an inverse model will be described below.

The inputs of this process are the inverse model P(aₜ|sₜ₊₁, sₜ) and the value function V(sₜ).

The output of this process is the distribution of policies P(aₜ|sₜ) shown in Expression (49).

First, a case where a change occurs along the time axis in a given environment will be described. It is assumed that the value function is optimized.

In this case, the TD error δ becomes 0 as shown in Expression (55).

$$[ Expression 55 ]$$

$$TD - error δ = r ( {s}_{t} , {a}_{t} ) - {V}_{π} ( {s}_{t} ) + γ {V}_{π} ( {s}_{t + 1} ) = 0 \qquad ( 55 )$$

$${V}_{π} ( {s}_{t} ) = r ( {s}_{t} , {a}_{t} ) + γ {V}_{π} ( {s}_{t + 1} )$$

ε is a variable that takes on real values. Using this variable ε, Expression (56) holds true from Expression (55).

$$[ Expression 57 ]$$

$$∃ ε ∈ ℝ . V ( {s}_{t} + ϵ \frac{\partial V ( {s}_{t} )}{\partial {s}_{t}} ) \geq V ( {s}_{t} ) \qquad ( 56 )$$

According to the above Expression (56), it is shown that in a state after an infinitesimal change Δs occurs from state sₜ (e.g., state sₜ₊₁), a value can be derived using the same value function as in state sₜ.

State sₜ₊₁ is defined using Expression (57) including the environment function f.

If the policy function π is optimized, then the value V in state sₜ₊₁ becomes the value V in state sₜ plus ΔV. ΔV is a real number equal to or greater than 0.

[Expression 57]

sₜ₊₁=f(sₜ,π(sₜ)) (57)

If the small change Δs is not 0, Expression (58) holds true. Both sides of this Expression (58) are normalized to obtain Expression (59).

$$[ Expression 58 ]$$

$$\frac{V ( {s}_{t} + Δ s ) - V ( {s}_{t} )}{Δ s} ≃ \frac{\partial V ( {s}_{t} )}{\partial {s}_{t}} ∞ ∈ \frac{\partial f ( {s}_{t} , π ( {s}_{t} ) )}{\partial {s}_{t}} = Δ s \qquad ( 58 )$$

$$[ Expression 59 ]$$

$$\frac{1}{{‖ \frac{\partial V ( {s}_{𝔱} )}{\partial {s}_{t}} ‖}_{2}} \frac{\partial V ( {s}_{t} )}{\partial {s}_{t}} = \frac{1}{{‖ {s}_{t + 1} - {s}_{𝔱} ‖}_{2}} ( {s}_{t + 1} - {s}_{t} ) \qquad ( 59 )$$

### Usage:

During the learning process, the constraint according to Expression (59) above is introduced. That is, this expression is equivalent to the minimum value indicated by Expression (60).

$$[ Expression 60 ]$$

$$minimize {‖ \frac{{∇}_{{s}_{t}} V}{{‖ {∇}_{{s}_{t}} V ‖}_{2}} \frac{{s}_{t + 1} - {s}_{t}}{{‖ {s}_{t + 1} - {s}_{t} ‖}_{2}} ‖}_{2} \qquad ( 60 )$$

During the learning process, the constraint according to Expression (59) above is introduced. That is, this expression is equivalent to the minimum value indicated by Expression (60).

For example, in a case where Expression (61) holds, the update of either or both of the parameters θv and θπ may be canceled.

$$[ Expression 61 ]$$

$${[ \frac{\partial V ( {s}_{t} )}{\partial {s}_{t}} ]}^{T} [ {s}_{r + 1} - {s}_{t} ] > ϵ > 0 \qquad ( 61 )$$

FIG. 12 is a diagram for explaining the gradient of the value function in a state space showing the relationship between the parameter θᵥ and the state s in some example embodiments of the present disclosure.

The horizontal axis represents the parameter θᵥ, and the vertical axis represents the change in state s.

For a value function V(sₜ, θᵥ) in state sₜ and parameter θᵥ, the gradient of the value function V at the time of state sₜ, which is an element of the data set D, can be specified for each axis component. On the other hand, in a case where the state sₜ changes to state sₜ₊₁, the gradient of the value function V may be corrected to reflect the influence of the state change.

Referring to FIG. 13, the processing of the calculation processing device according to some example embodiments of the present disclosure will be described.

FIG. 13 is a flowchart for explaining the processing by the calculation processing device according to some example embodiments of the present disclosure.

The data acquisition portion 131 receives a user operation performed on the input/output portion 16 (S11). The mode control portion 132 identifies the control mode requested by the user and assigns it to the next process (S12). The learning preparation mode, the learning mode, and the control execution mode are examples of modes related to the next process.

If the request is for the learning preparation mode, the data acquisition portion 131 acquires information on the environment s and the action a in pairs (S21), assigns identification information to the information on the environment s and the action a, and adds the information on the environment s and the action a to the data set D. This data may be acquired, for example, at a predetermined cycle, by acquiring information on the environment s and the action a, or by acquiring all of the data already stored. This process ends in a case where a predetermined number of data items have been acquired.

If the request is for the learning mode, the probability distribution estimation portion 134 performs a process of estimating a probability distribution based on the data of the accumulated data set D. The probability distribution estimation portion 134 estimates this probability distribution to derive, for example, a policy distribution and distributions of a value function and a reward function (S31).

Next, if the probability distribution (first probability distribution) generated by the estimation process by the probability distribution estimation portion 134 is dissociated from a Gaussian distribution, the probability distribution approximation portion 135 generates a probability distribution (second probability distribution) by converting the probability distribution (first probability distribution) generated by the estimation process by the probability distribution estimation portion 134 (S32). The process of Step S32 may be performed as necessary.

Next, the balance adjustment portion 136 may execute a balance process of alternately selecting items for the estimation process so as to prevent bias in the probability distribution estimated by the probability distribution estimation portion 134 (S33).

Next, value function adjustment portion 137 adjusts the gradient of value function V in the state space (S34). The process of Step S34 may be performed as necessary.

In a case where each variable is determined by carrying out each of the above processes, the control portion 13 ends this learning process that has been carried out offline.

In addition, in the above learning process, the control portion 13 (calculation processing portion) uses an internal evaluation function in reinforcement learning to determine at least one of an evaluation value for an operation in a state within an environment including the control object and an evaluation value for the next state of that state. The control portion 13 determines an operation relating to the control object based on the obtained evaluation value.

For example, the internal evaluation function may be a value function in reinforcement learning. In this case, the control portion 13 may configure the value function of the reinforcement learning using trajectory data indicating a frequency distribution based on the frequency of states. Alternatively, in this case, instead of the above, the control portion 13 may configure the policy function of the reinforcement learning using trajectory data based on a conditional probability depending on the state of the action determined in the reinforcement learning. An example of the locus data referred to here is the curve in the distribution diagram shown in FIG. 6A, and the curve showing the distribution after mapping shown in FIG. 7.

For example, a value function in reinforcement learning may be a function based on trajectory data that indicates a frequency distribution based on the frequency of states. In this case, the control portion 13 may configure a policy function in reinforcement learning using trajectory data based on conditional probabilities depending on the state of an action determined in reinforcement learning.

If the request is for the control execution mode, the control execution portion 133 controls the plant P to be controlled by utilizing the results of the previously executed learning process. The control system 1 is operated for a required period, and then the control system is stopped.

According to some example embodiments of the present disclosure described above, the control device 10 (learning device) is equipped with a calculation processing portion that uses an internal evaluation function in reinforcement learning to calculate at least one of an evaluation value for an operation in a state in an environment including a control target and an evaluation value for a next state of the state, and determines an operation regarding the control target based on the calculated evaluation value. The internal evaluation function is defined so as to generate the evaluation value indicating that the higher the frequency of a state in the desired operation of the control target, the higher the evaluation value. This enables the control system 1 to reduce the amount of calculations required in reinforcement learning.

In addition, the control system 1 is a calculation processing device for optimizing a control system whose control variables include state, action, and value, and is equipped with a calculation processing portion that constructs a value function or policy function of reinforcement learning for controlling the control system using trajectory data based on the empirical values of the state related to the control system. As a result, the control system 1 can be realized with an optimizable configuration for a control system that requires control safety.

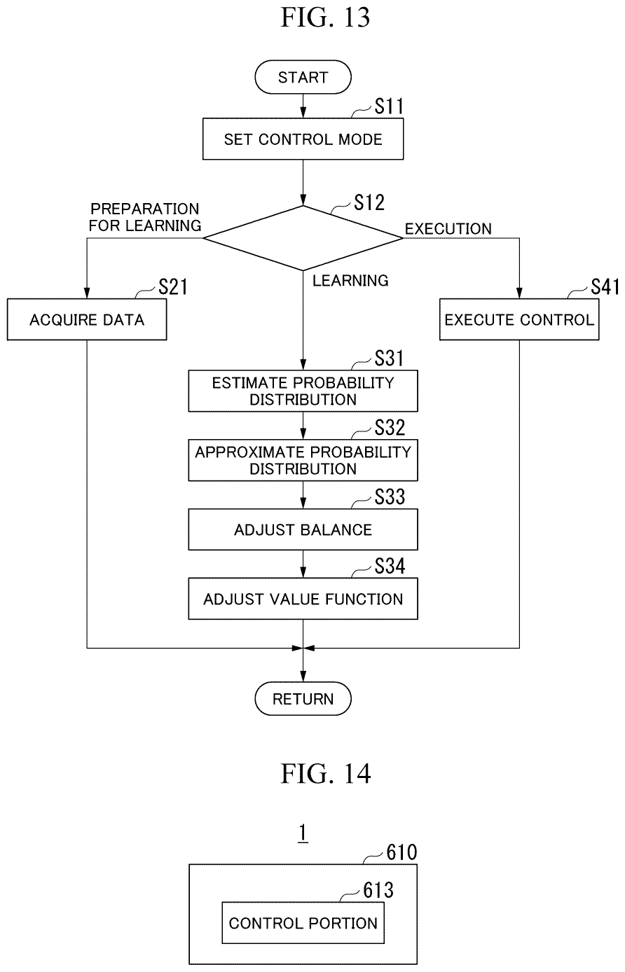

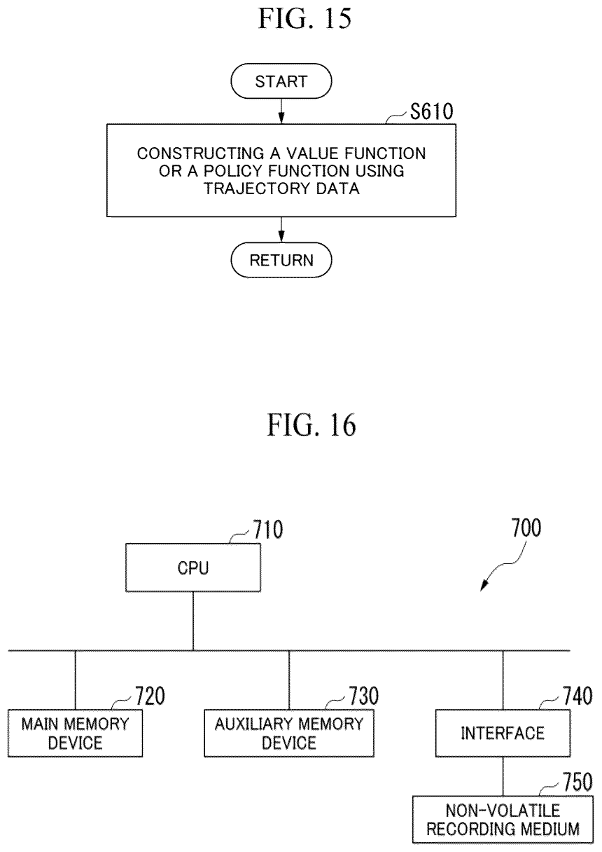

A more simply configured example embodiment will be described with reference to FIG. 14 and FIG. 15.

FIG. 14 is a diagram illustrating an example of a configuration of the calculation processing device according to some example embodiments of the present disclosure. In the configuration shown in FIG. 14, a calculation processing device 610 is provided with a calculation processing portion 611.

With this configuration, the calculation processing portion 611 configures a value function or a policy function of reinforcement learning for controlling the control system 1 using trajectory data based on the empirical values of the states related to the control system 1.

FIG. 15 is a flowchart illustrating an example of a processing procedure in a computation method according to some example embodiments of the present disclosure. The computation method shown in FIG. 15 includes constructing a value function or a policy function for reinforcement learning using trajectory data based on empirical values of states (Step S610). This allows optimization of control systems where safety of control is required.

FIG. 16 is a schematic block diagram illustrating a configuration of a computer according to at least one example embodiment.

In the configuration shown in FIG. 16, a computer 700 is provided with a CPU 710, a main memory device 720, an auxiliary memory device 730, an interface 740, and a non-volatile recording medium 750.

Any one or more of the above-described calculation processing device 10 and control system 1 or a part thereof may be implemented in the computer 700. In this case, the operations of the above-mentioned processing portions are stored in the auxiliary memory device 730 in the form of a program. The CPU 710 reads the program from the auxiliary memory device 730, loads it into the main memory device 720, and executes the above-mentioned processing in accordance with the program. Furthermore, the CPU 710 allocates storage areas in the main memory device 720 corresponding to the above-mentioned respective memory portions in accordance with the program. Communication between each device and other devices is performed by the interface 740 having a communication function and performing communication under the control of the CPU 710.

In a case where the calculation processing device 10 is implemented in the computer 700, the operations of the neural network device and each of its components are stored in the auxiliary memory device 730 in the form of a program. The CPU 710 reads the program from the auxiliary memory device 730, loads it into the main memory device 720, and executes the above-mentioned processing in accordance with the program.

Furthermore, the CPU 710 reserves a memory area in the main memory 720 for processing by the calculation processing device 10 in accordance with the program. Communications between the calculation processing device 10 and other devices are performed by the interface 740 having a communication function and operating under the control of the CPU 710. Interaction between the calculation processing device 10 and a user is performed by the interface 740, which includes a display device and an input device, displaying various images under the control of the CPU 710, and accepting user operations.

In addition, a program for executing all or part of the processing performed by the calculation processing device 10 may be recorded on a computer-readable recording medium, and the program recorded on this recording medium may be read into a computer system and executed to perform processing of each part. It should be noted that the term “computer system” herein includes the OS and hardware such as the peripheral devices.

In addition, the term “computer-readable recording medium” refers to portable media such as flexible disks, optical magnetic disks, ROMs (Read Only Memory), and CD-ROMs (Compact Disc Read Only Memory), as well as storage devices such as hard disks built into computer systems. Furthermore, the above program may be for realizing some of the functions described above, and may further be capable of realizing the functions described above in combination with a program already recorded in the computer system.

Although several example embodiments of the present disclosure have been described in detail above with reference to the drawings, the specific configurations are not limited to these example embodiments, and designs that do not deviate from the gist of this disclosure are also included.

FIG. 3B is a diagram for explaining another application example of some example embodiments of the present disclosure.

The time chart shown in this figure shows the procedure for restoring operational status in railway traffic management. For example, a service may be interrupted due to an accident in the middle of a scheduled operation, and after this interruption, it will go through a stage of rescheduling before regular service is restored. Such an interruption may occur again.

As described above, in a case where the operation state changes, control is performed to stabilize the state in the unsteady state control. It is observed that the state during control of such an unsteady state tends to be unstable, but by applying some example embodiments of the present disclosure, it becomes possible to control the state in a stable manner.

Some control systems have internal states that change during operation, and even if the input remains the same, the output is determined by the changed internal states.

For example, according to a reinforcement learning technique of the comparative example, in a case where optimizing a controller that controls a control target to match the state of the control target, a calculation to search for a more optimal solution is performed for each control period in which the control target is controlled. If such a comparative example is applied, it will take a long time to obtain an optimal solution.

In contrast, according to the reinforcement learning techniques of some example embodiments of the present disclosure, optimal solutions corresponding to each internal state can be prepared in advance through offline learning, making it possible to perform control without the time required in the comparative example.

Some or all of the above-described example embodiments may be described as, but is not limited to, the following supplementary notes.

### (Supplementary Notes)

[1] One aspect is a learning device comprising a calculation processing portion that uses an internal evaluation function in reinforcement learning to determine at least one of an evaluation value for an operation in a state in an environment including a control object and an evaluation value for the next state of the state, and determines an operation relating to the control object on the basis of the determined evaluation value, wherein the internal evaluation function is stipulated so as to generate the evaluation value indicating that the higher the frequency of a state in the desired operation of the control object, the higher the evaluation.
[2] The internal evaluation function in the calculation processing device of [1] above may be a value function in the reinforcement learning, and the calculation processing unit may configure the value function of the reinforcement learning using trajectory data that shows a frequency distribution based on the frequency of the state.
[3] The internal evaluation function in the calculation processing device of [1] above may be a value function in the reinforcement learning, and the calculation processing unit may configure a policy function of the reinforcement learning using trajectory data based on a conditional probability depending on the state of the action determined in the reinforcement learning.
[4] In the calculation processing device of [1] above, the value function in the reinforcement learning may be a function based on trajectory data indicating a frequency distribution based on the frequency of the state, and the calculation processing portion may configure a policy function in the reinforcement learning using trajectory data based on a conditional probability depending on the state of the action determined in the reinforcement learning.
[5] In the processing device of [1] above, the policy distribution of the reinforcement learning may be a probability that an action a is selected in a state s at a certain stage among a plurality of stages of state transitions, and the state value function of the reinforcement learning may be set using a TD (Temporal Difference) error of the reinforcement learning.
[6] The calculation processing portion of [4] above may, in estimating the distribution of the value function and the policy function, add noise to either or both of the state and the action, and apply regularization to reduce the frequency of the state to which the noise has been added or the action to which the noise has been added.
[7] The calculation processing portion of [4] above may control the control system using a value function or policy function of the reinforcement learning.
[8] The calculation processing portion of [4] above may normalize the magnitude of the gradient of the value function of the reinforcement learning and use the normalized value as an initial value.
[9] The calculation processing portion of [1] may record the state of the environment in a case where the control object is controlled by an operation determined based on an expert's operation or command for the control of the control object, and obtain the frequency of the state based on the record.
[10] A control system according to one example embodiment includes the learning device according to any one of [1] to [9] above, and a control portion that has undergone offline reinforcement learning by the learning device based on the frequency of the state, wherein the control portion controls the control object using a result of the offline reinforcement learning.
[11] One aspect may be a learning method that includes using an internal evaluation function in reinforcement learning to determine at least one of an evaluation value for an operation in a state in an environment including a control object and an evaluation value for the next state of the state, and determining an operation relating to the control object on the basis of the determined evaluation value, wherein the internal evaluation function is stipulated so as to generate the evaluation value indicating that the higher the frequency of a state in the desired operation of the control object, the higher the evaluation.
[12] One aspect may be a program for causing a device that executes a program for a learning process related to reinforcement learning to use an internal evaluation function in reinforcement learning to determine at least one of an evaluation value for an operation in a state in an environment including a control object and an evaluation value for the next state of the state, to determine an operation of the control target based on the obtained evaluation value, and to generate, by the internal evaluation function, the evaluation value indicating that the higher the frequency of a state in the desired operation of the control object, the higher the evaluation.

Priority is claimed on Japanese Patent Application No. 2022-180039, filed on Nov. 10, 2022, the content of which is incorporated herein by reference.

### INDUSTRIAL APPLICABILITY

The present disclosure may be applied to a learning device, a control system, a learning method, and a recording medium.

### DESCRIPTION OF REFERENCE SIGNS

1 Control system
10, 610 Calculation processing device (learning device)
13,613 Control portion
15 Memory portion

1. A learning device comprising:
at least one memory configured to store instructions; and
at least one processor configured to execute the instructions to:
use an internal evaluation function in reinforcement learning to determine at least one of an evaluation value for an operation in a state in an environment including a control object or an evaluation value for a next state of the state; and
determine an operation relating to the control object on the basis of the determined evaluation value,
wherein the internal evaluation function is stipulated so as to generate the evaluation value indicating that the higher a frequency of a state in a desired operation of the control object, the higher an evaluation.

2. The learning device according to claim 1,
wherein the internal evaluation function is a value function in the reinforcement learning, and
wherein the at least one processor is configured to execute the instructions to configure the value function of the reinforcement learning using trajectory data that shows a frequency distribution based on the frequency of the state.

3. The learning device according to claim 1,
wherein the internal evaluation function is a value function in the reinforcement learning, and
wherein the at least one processor is configured to execute the instructions to configure a policy function of the reinforcement learning using trajectory data based on a conditional probability depending on the state of an action determined in the reinforcement learning.

4. The learning device according to claim 1,
wherein a value function in the reinforcement learning is a function based on trajectory data indicating a frequency distribution based on the frequency of the state, and
wherein the at least one processor is configured to execute the instructions to configure a policy function in the reinforcement learning using trajectory data based on a conditional probability depending on the state of an action determined in the reinforcement learning.

5. The learning device according to claim 4,
wherein a policy distribution of the reinforcement learning is a probability that an action a is selected in a state s at a certain stage among a plurality of stages of state transitions, and
wherein a state value function of the reinforcement learning is set using a Temporal Difference (TD) error of the reinforcement learning.

6. The learning device according to claim 4,
wherein the at least one processor is configured to execute the instructions to, in estimating a distribution of the value function and the policy function, add noise to either or both of the state and the action, and apply regularization to reduce the frequency of the state to which the noise has been added or the action to which the noise has been added.

7. The learning device according to claim 4,
wherein the at least one processor is configured to execute the instructions to control the control object using the value function or policy function of the reinforcement learning.

8. The learning device according to claim 4,
wherein the at least one processor is configured to execute the instructions to normalize a magnitude of a gradient of the value function of the reinforcement learning, and use the normalized value as an initial value.

9. The learning device according to claim 1,
wherein the at least one processor is configured to execute the instructions to record the state of the environment in a case where the control object is controlled by an operation determined based on an expert's operation or command for controlling of the control object, and obtain the frequency of the state based on the record.

10. A control system comprising
the learning device according to claim 1 and
a controller that has undergone offline reinforcement learning by the learning device based on the frequency of the state,
wherein the controller controls the control object using a result of the offline reinforcement learning.

11. A learning method that includes:
using an internal evaluation function in reinforcement learning to determine at least one of an evaluation value for an operation in a state in an environment including a control object or an evaluation value for a next state of the state; and
determining an operation relating to the control object on the basis of the determined evaluation value,
wherein the internal evaluation function is stipulated so as to generate the evaluation value indicating that the higher a frequency of a state in a desired operation of the control object, the higher an evaluation.

12. A non-transitory recording medium storing a program for causing a device that executes a program of a learning process related to reinforcement learning to execute:
using an internal evaluation function in reinforcement learning to determine at least one of an evaluation value for an operation in a state in an environment including a control object or an evaluation value for a next state of the state; and
determining an operation relating to the control object on the basis of the determined evaluation value,
wherein the internal evaluation function is stipulated so as to generate the evaluation value indicating that the higher a frequency of a state in a desired operation of the control object, the higher an evaluation.
